(19) United States
(12) Patent Application Publication
(10) Pub. No.: US 2022/0400890 A1
(43) Pub. Date: Dec. 22, 2022

(54) COFFEE MAKER WITH CUSTOM BREW

(71) Applicant: Haier US Appliance Solutions, Inc., Wilmington, DE (US)

(72) Inventors: Samuel Vincent DuPlessis, Louisville, KY (US); Eric Muzzillo, Louisville, KY (US); Andre Zdanow, Louisville, KY (US)

(21) Appl. No.: 17/351,734

(22) Filed: Jun. 18, 2021

(51) Int. Cl. A47J 31/52; A47J 31/00; A47J 31/10; A47J 31/46

(52) U.S. Cl. CPC A47J 31/5253; A47J 31/5255; A47J 31/002; A47J 31/10; A47J 31/468; A47J 31/521

(57) ABSTRACT

A method of operating a coffee making appliance includes receiving an input from a user interface of the coffee making appliance. In response to the received input, a pump of the coffee making appliance is activated to pump an initial volume of water from a reservoir to a brew basket. The pump is then paused for a bloom time after pumping the initial volume of water. The bloom time is based on the input from the user interface. The method also includes activating the pump to pump a second volume of water from the reservoir to the brew basket after the bloom time.

### FIELD OF THE INVENTION

The present subject matter relates generally to coffee making appliances, and more particularly to a coffee making appliance with improved brewing features.

### BACKGROUND OF THE INVENTION

There are many parameters for a brewing process in a coffee making appliance. However, typical coffee making appliances have limited user interfaces and/or limited programming such that the typical coffee making appliance does not permit a user to customize specific parameters, such as brewing time, water temperature, and water flow rate, according to the user's exact preferences for a brewing operation in the coffee making appliance.

Accordingly, a coffee making appliance with features for increased customization of one or more brewing parameters is desired.

### BRIEF DESCRIPTION OF THE INVENTION

Aspects and advantages of the invention will be set forth in part in the following description, or may be apparent from the description, or may be learned through practice of the invention.

In one exemplary embodiment, a method of operating a coffee making appliance is provided. The coffee making appliance includes a reservoir, a pump, and a brew basket. The method includes receiving an input from a user interface of the coffee making appliance and activating the pump to pump an initial volume of water from the reservoir to the brew basket at a first flow rate based on the input received from the user interface. The method further includes heating the initial volume of water to a first temperature based on the input received from the user interface. The method also includes pausing the pump for a bloom time after pumping the initial volume of water. The bloom time is based on the input from the user interface. The method further includes activating the pump to pump a second volume of water from the reservoir to the brew basket after the bloom time at a second flow rate based on the input received from the user interface. The method also includes heating the second volume of water to a second temperature based on the input received from the user interface.

In a second exemplary embodiment, a coffee making appliance is provided. The coffee making appliance includes a reservoir, a pump, and a brew basket. The coffee making appliance also includes a controller. The controller is configured for receiving an input from a user interface of the coffee making appliance and activating the pump to pump an initial volume of water from the reservoir to the brew basket. The controller is also configured for setting a water temperature for the initial volume of water and setting a first flow rate of the pump for the initial volume of water to a desired level based on the received input from the user interface to achieve precise wetting of the coffee. The controller is also configured for pausing the pump for a bloom time after pumping the initial volume of water. The bloom time is based on the input from the user interface. The method further includes setting a second water temperature for a second volume of water, activating the pump to pump a second volume of water from the reservoir to the brew basket after the bloom time, and setting a second flow rate of the pump for the second volume of water to a desired level based on the received input from the user interface to achieve precise extraction of the coffee during the step of activated the pump to pump the second volume of water.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a partially exploded perspective view of an exemplary coffee making appliance according to one or more embodiments of the present subject matter.

FIG. 2 provides a flow diagram schematically illustrating selected components of the coffee making appliance of FIG. 1.

FIG. 3 provides a schematic illustration of a control system for a coffee making appliance according to one or more embodiments of the present subject matter.

FIG. 4 provides a flow chart of an exemplary method of operating a coffee making appliance according to one or more embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees either clockwise or counterclockwise with the vertical direction V.

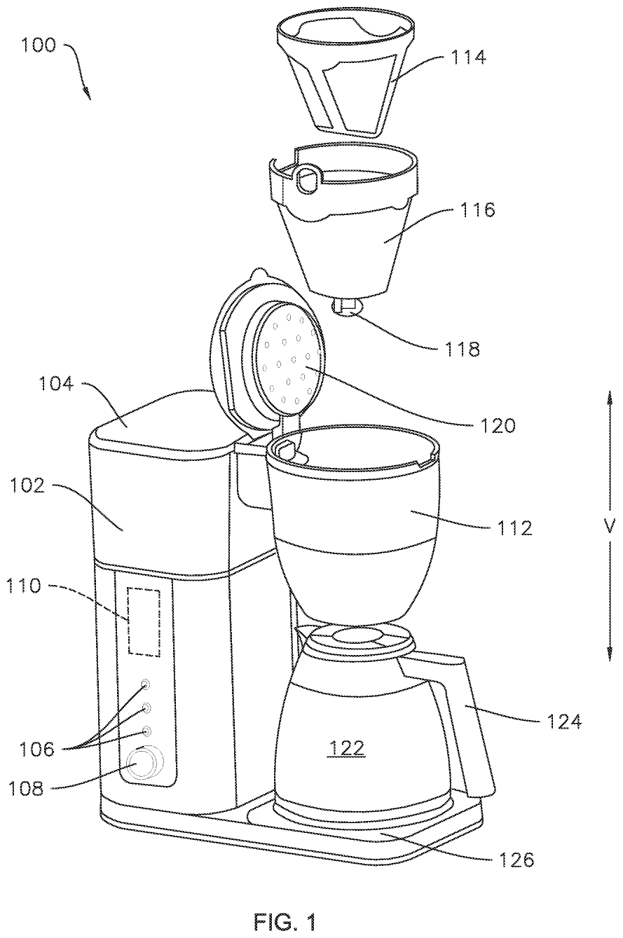

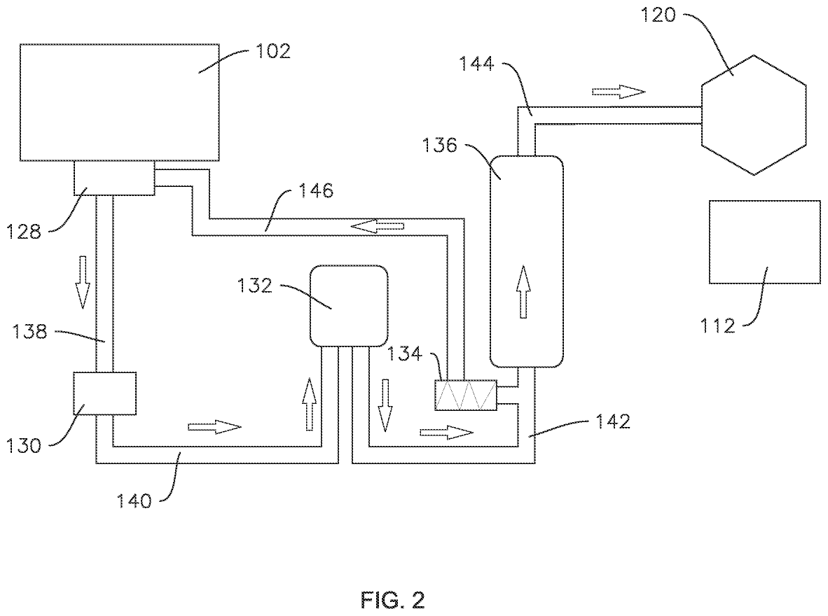

FIG. 1 provides a partially exploded perspective view of an exemplary coffee making appliance 100 (sometimes also referred to as a coffee maker) according to one or more embodiments of the present subject matter. As illustrated in FIG. 1, the coffee making appliance 100 defines a vertical direction V. In various exemplary embodiments, the coffee making appliance 100 may include a water tank or reservoir 102 which is open at a top end thereof and is selectively enclosed by a reservoir lid 104. The reservoir lid 104 may be rotatably mounted, e.g., by one or more hinges, to the top end of the reservoir 102 to selectively rotate between a closed position (e.g., as illustrated in FIG. 1) where the reservoir 102, and in particular the open top end thereof, is enclosed by the lid 104 and an open position (not shown) permitting access to the reservoir 102, e.g., so that a user may fill the reservoir with water for coffee brewing. Water in the reservoir 102 may be drawn from the reservoir to a brew basket 112 by a pump 132 (FIG. 2), as will be described in more detail below.

In some embodiments, the coffee making appliance 100 may also include a filter 114, e.g., a mesh basket filter as in the example embodiment illustrated in FIG. 1, and a brew basket insert 116. As illustrated in FIG. 1, the filter 114 and the brew basket insert 116 are configured, e.g., sized and shaped, for nesting engagement with each other and with the brew basket 112. In particular, the filter 114 may be configured to fit within the brew basket insert 116 and the brew basket insert 116 may be configured to fit within the brew basket 112, e.g., with the filter 114 disposed within the brew basket insert 116 while the insert 116 is positioned within the brew basket 112. Thus, the filter 114 may receive coffee grounds for brewing and the filter 114, e.g., with grounds therein, may be received within the brew basket insert 116 while the brew basket insert 116 is received within the brew basket 112.

The coffee maker appliance 100 may further include a shower head 120 which is configured to be disposed above the brew basket 112 along the vertical direction V for providing a flow of, e.g. water, from the reservoir 102 to the brew basket 112, and in particular to the brew basket insert 116, the filter 114, and coffee grounds disposed therein, which are nested within the brew basket 112 as described above. In particular, the shower head 120 may receive the flow of water from the reservoir 102 via the pump 132. In various embodiments, the pump 132 may be or include any suitable device for motivating the liquid, e.g., water, from the reservoir 102 to the shower head 120. For example, in some embodiments, the pump 132 may be a mechanical pump including an impeller (not shown) which motivates the liquid into and/or through the pump 132. In additional example embodiments, the heater 136 (described below) may also or instead motivate the liquid, e.g., in addition to or instead of the separate pump 132 illustrated in the example embodiment of FIG. 2, such as by heating the water until it expands into and through a conduit, e.g., outlet line and/or a portion 144 thereof, as described in more detail below, upstream of the shower head 120 and ultimately to the shower head 120 itself

The shower head 120 is configured to provide a drip flow of water to the brew basket 112, e.g., the shower head 120 may include a plurality of outlets in order to form a slow, diffuse flow of water which is evenly distributed across the horizontal cross-sectional area of the brew basket 112. In additional embodiments, other suitable nozzle or spout configurations for providing and directing the flow of water from the reservoir 102 via the pump 132 into the brew basket 112 may be provided as well as or instead of the shower head 120, such as a plurality of discrete nozzles (in contrast to the multiple outlets formed in the single unitary body of the shower head 120 as illustrated FIG. 1), among other possible example embodiments.

A thermal carafe 122 may be removably positioned below the brew basket 112 along the vertical direction V. The coffee making appliance 100 may include a hot plate 126 which is configured to provide thermal energy to the carafe 122 and contents thereof when the carafe 122 is positioned below the brew basket 112 and on top of the hot plate 126, e.g., as illustrated in FIG. 1. With the thermal carafe 122 so positioned, the thermal carafe 122 may receive a flow of liquid, e.g., coffee, from the brew basket 112 by gravity. The thermal carafe 122 may include a handle 124 which a user may grasp, e.g., in order to place the carafe 122 on the hot plate 126 and below the brew basket 112 and/or to remove the carafe 122 therefrom in order to access liquid coffee in the carafe 122, e.g., the liquid coffee may be poured from the carafe 122 into a suitable container for consumption, such as a mug or thermos, etc. The handle 124 may be formed of a thermally insulating material, e.g., plastic, and may thereby provide a cool, safe touch surface or surfaces for the user.

As may be seen in FIG. 1, the brew basket insert 116 may include a drip stop lever 118, e.g., which actuates a valve to open the valve and thereby permit liquid flow from the brew basket 112 and/or from the brew basket insert 116 into the thermal carafe 122. For example, the drip stop lever 118 may be configured to extend from the brew basket 112, e.g., below the brew basket 112 along the vertical direction V, when the brew basket insert 116 is received within the brew basket 112. Thus, when the thermal carafe 122 is positioned below the brew basket 112 and aligned with the brew basket 112 to receive the liquid flow therefrom, the thermal carafe 112 may engage the drip stop lever 118, e.g., may push the drip stop lever 118 upward along the vertical direction V, to thereby open the valve and permit liquid, e.g., coffee, flow from the brew basket 112 into the carafe 122, e.g., by gravity as mentioned above.

FIG. 2 provides a flow diagram schematically illustrating selected components of the coffee making appliance 100 which are in fluid communication with each other, e.g., where fluid such as water flows between and amongst the several components which are illustrated schematically in FIG. 2 as indicated by arrows in FIG. 2.

As illustrated in FIG. 2, the reservoir 102 may be coupled to the pump 132 by an inlet line 138, 140. The inlet line may include a first portion 138 upstream of a flow meter 130 and a second portion downstream of the flow meter 130. Additionally, the coffee making appliance 100 may also include a water filter 128, e.g., containing one or more filter media enclosed therein such as activated carbon, a filter membrane, etc., coupled to the reservoir 102, such as directly coupled to the reservoir 102 at an upstream end of the first portion 138 of the inlet line. In particular, the first portion 138 of the inlet line may extend from the water filter 128 and/or reservoir 102 to the flow meter 130, such as may be directly connected to the water filter 128 and/or reservoir 102 at the upstream terminal end of the first portion 138 of the inlet line and may be directly connected to the flow meter 130 at a downstream terminal end of the first portion 138 of the inlet line, whereby the reservoir 102 and the flow meter 130 are in fluid communication via the first portion 138 of the inlet line, e.g., whereby water may flow in the direction indicated by the arrow next to (left of) first portion 138 in FIG. 2 from the reservoir 102 to the flow meter 130. The second portion 140 of the inlet line may extend from the flow meter 130 to the pump 132, e.g., the second portion 140 of the inlet line may be directly connected to each of the flow meter 130 and the pump 132 at a respective one of two terminal ends of the second portion 140, in particular to the flow meter 130 at an upstream end and to the pump 132 at a downstream end. Thus, the flow meter 130 and the pump 132 are in fluid communication via the second portion 140 of the inlet line, e.g., whereby water may flow in as indicated by the arrows next to second portion 140 in FIG. 2 from the flow meter 130 to the pump 132. Accordingly, the pump 132, when activated, may urge or draw liquid, e.g., water, from the reservoir 102 through the water filter 128 (in embodiments which include the water filter 128) and through the flow meter 130 to the pump 132.

The pump 132 may also urge or discharge the liquid to the shower head 120 via an outlet line. In some embodiments, the outlet line may include a first portion 142 which extends from the pump 132 to a boiler or heater 136. For example, the heater 136 may be a tubular member with a heating element embedded or enclosed therein, whereby the heater 136 may raise the temperature of the water as the water flows through the tubular heater 136. The heater 136 may be, e.g., a calrod or other suitable tubular heater. In particular, the first portion 142 of the outlet line may extend from the pump 132 to the heater 136, such as may be directly connected to the pump 132 at an upstream terminal end of the first portion 142 of the outlet line and may be directly connected to the heater 136 at a downstream terminal end of the first portion 142 of the outlet line, whereby the pump 132 and the heater 136 are in fluid communication via the first portion 142 of the outlet line, e.g., whereby water may flow as indicated by the arrows next to first portion 142 in FIG. 2 from the pump 132 to the heater 136. In other embodiments, as mentioned above, the heater 136 may serve as the pump, e.g., by heating the water until it expands into the outlet line, such as without a separate pump 132 (the outlet line in such embodiments including a single portion extending continuously from the heater/pump to the shower head, e.g., without a separate component, such as a heater or pump, between the heater 136 and the shower head 120).

The coffee making appliance 100 may also include a pressure relief valve 134, such as a spring valve, which is coupled to the first portion 142 of the outlet line and to a pressure release line 146, with the pressure release line downstream of the valve 134. The valve 134 may be configured to open at or above a certain pressure level, e.g., based on the biasing force of the spring in embodiments where the pressure relief valve 134 is a spring valve, in order to avoid excessive pressure within the outlet line and/or heater 136. The pressure relief valve 134 may be configured to direct a portion of the water flowing through the outlet line into the pressure release line 146, e.g., depending on whether and to what extent the pressure relief valve 134 is opened. For example, the spring (in spring valve embodiments) may bias the pressure relief valve 134 to or towards a closed position wherein the water flows entirely or approximately entirely through the first portion 142 of the outlet line to the heater 136 when the valve 134 is in the closed position and, when the water pressure in the outlet line, e.g., first portion 142 thereof, rises to a level that is sufficient to overcome the biasing force of the spring, the valve 134 will move to or towards an open position, such as a partially open position, allowing a portion of the water from the outlet line to flow into the pressure release line 146, thereby reducing the pressure in the outlet line. In additional exemplary embodiments, the pressure relief valve 134 may also or instead be connected to a second portion 144 of the outlet line that is downstream of the heater 136.

The outlet line may further include the second portion 144, e.g., downstream of the first portion 142 of the outlet line. The second portion 144 of the outlet line may extend from the heater 136 to the shower head 120, e.g., the second portion 144 of the outlet line may be directly connected to each of the heater 136 and the shower head 120 at a respective one of two terminal ends of the second portion 144, in particular to the heater 136 at an upstream end and to the shower head 120 at a downstream end. Thus, the heater 136 and the shower head 120 are in fluid communication via the second portion 144 of the outlet line, e.g., whereby water may flow in as indicated by the arrow next to (above) second portion 144 in FIG. 2 from the heater 136 to the shower head 120. Accordingly, the pump 132, when activated, may urge or discharge liquid, e.g., water, from the pump 132 through the heater 136 and to the shower head 120. As illustrated in FIG. 2, the water, which has been heated in the heater 136, may flow from the shower head 120 to the brew basket 112, e.g., to interact with coffee grounds therein for brewing coffee.

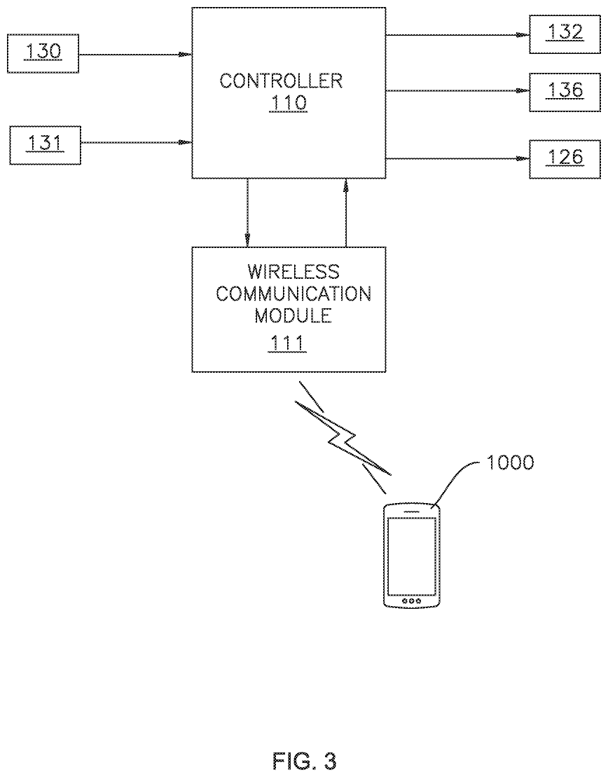

Turning again to FIG. 1, in some embodiments, one or more selector inputs, such as buttons 106, one or more knobs 108, a touchpad, or touchscreen interfaces, etc., may be provided or mounted on the coffee making appliance 100, e.g., on a control panel thereof and are in operable communication (e.g., electrically coupled or coupled through a wireless network band) with a processing device or controller 110, such as via one or more signal lines or shared communication busses. In response to user manipulation of the selector inputs, controller 110 operates the various components of coffee making appliance 100 to execute selected cycles and features. The control panel may also include a display. As illustrated in FIG. 3, controller 110 may also be provided in operable communication with various components of the coffee making appliance, such as the flow meter 130, pump 132, hot plate 126, and heater 136, as well as one or more sensors such as temperature sensors 131, e.g., thermocouples, thermistors, or other suitable temperature sensors. In turn, signals generated in controller 110 direct operation of such components in response to the inputs 106 and/or 108. As used herein, “processing device” or “controller” may refer to one or more microprocessors, microcontroller, ASICS, or semiconductor devices and is not restricted necessarily to a single element. The controller 110 may be programmed to operate coffee making appliance 100 by executing instructions stored in memory (e.g., non-transitory media). The controller 110 may include, or be associated with, one or more memory elements such as RAM, ROM, or electrically erasable, programmable read only memory (EEPROM). In one embodiment, the processor executes programming instructions stored in memory. The memory may be a separate component from the processor or may be included onboard within the processor. For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller.

As illustrated in FIG. 3, the controller 110 received inputs, e.g., signals from the flow meter 130 and from the temperature sensor(s) 131. Such signals may represent or correspond to a detected or measured value from the respective meter or sensor, such as a measured flow rate and/or flow count from the flow meter 130, or a measured or sensed temperature, e.g., water temperature of water in the heater 136 or of water downstream of the heater 136, or a temperature of the hot plate 126, from the one or more temperature sensor(s) 131. Also as may be seen, e.g., in FIG. 3, the coffee making appliance 100 may also include a wireless communication module 111, such as a WI-FI module. The wireless communication module 111 may be communicatively coupled to the controller 110 to send and receive signals to and from the controller 110, such as user inputs, user selections, or other inputs. For example, such inputs or selections may be received by the wireless communication module 111 from a remote user interface device 1000 and transmitted to the controller 110 by the wireless communication module 111. The remote user interface device 1000 may be a smartphone, tablet, computer, smart home system, or other similar device which is “remote” from the coffee making appliance 100 in that the device 1000 is not, or need not be, physically connected to or integrated with the coffee making appliance 100. The remote user interface device 1000 may include a memory for storing and retrieving programming instructions. For example, the remote user interface device 1000 may be a smartphone operable to store and run applications, also known as “apps,” and may include a remote user interface provided as a smartphone app.

An exemplary brewing operation of the coffee making appliance 100 may include three main phases, a start phase including initial wetting of the coffee grounds, a bloom phase during which the coffee grounds are immersed in an initial volume of water, and a brewing phase. Additionally, the brewing phase may include multiple stages. As an initial matter, the reservoir may be filled with water and the filter 114 may be filled with coffee grounds, while the filter 114 is nested within the brew basket insert 116 and the brew basket 112. The coffee making appliance 100 may then be activated in response to one or more inputs, certain embodiments of which will be described in more detail below. When the coffee making appliance 100 is thus activated and the start phase commences, the pump 132 will urge the water from the reservoir 102, through the heater 136 whereby the temperature of the water is elevated to a defined brewing temperature, and to the shower head 120. For example, the pump 132 may be activated long enough to fill the heater 136, then pause briefly, e.g., for about three seconds or less, to allow the water to reach the defined brew temperature, then the pump 132 is reactivated to deliver the flow of water to the shower head 120. From the shower head 120, the heated water falls and/or drips onto, over, and around the coffee grounds in the filter 114. During the start phase, a first or initial volume of water may be provided to the brew basket 112 to saturate the coffee grounds within the filter 114, while still being a small enough volume of water to avoid or minimize over wetting the grounds or overflowing from the filter 114 and/or insert 116 into the thermal carafe 122. For example, in some embodiments, the initial volume of water may be customized, e.g., based on and in response to a user input, to achieve precise wetting of the coffee grounds for the desired outcome, such as desired strength and/or flavor profile of the brewed coffee. After pumping the initial volume, the start phase concludes and the brewing operation moves into the bloom phase. During the bloom phase, the pump 132 may be paused or may dwell, allowing the grounds to soak up the initial volume of water within the brew basket 112. The grounds swell or bloom while they absorb the water as they sit and soak in the brew basket 112 during the pump dwell time, and the pump dwell time may also be referred to as immersion time, because the grounds are immersed in the initial volume of water during this time, or as a bloom time because the grounds swell or bloom during this time. As the coffee grounds become fully saturated, the heated water extracts constituents, e.g., oils and other substances, from the coffee grounds which combine with the water thereby forming, e.g. brewing, coffee within the brew basket 112. After a certain amount of immersion time or bloom time has elapsed, the bloom phase ends and the brewing phase begins. In the brewing phase, an additional volume or second volume of water is added to the brew basket 112 to over wet the grounds, causing the brewed coffee to flow through the filter 114 and from the brew basket insert 116 and brew basket 112 into the carafe 122, while the second volume of water also interacts with the coffee grounds to brew additional coffee which, in turn, ultimately flows to the carafe 122 as described. In some exemplary embodiments, the second volume of water may be customized, e.g., based on and in response to a user input, to achieve precise extraction of the constituents from the coffee grounds. Precise wetting and/or precise extraction are used herein to refer to the desired level of wetting and/or extraction to achieve the specific desired outcome (brew strength, etc.) based on the received user input, in contrast to a generic or default “one-size fits all” value for the initial volume and/or second volume of water which would be provided in the absence of the user input and customization. The total volume of water, e.g., the initial volume plus the second volume, used during the operation may be controlled by the controller 110. For example, a desired number of cups may be input or selected, e.g., using inputs 106 and/or 108, or via a remote user interface device, and the total volume of water supplied by the pump 132 may be set by the controller 110 based on the selected number of cups to brew. In some embodiments, the flow meter 130 may be used as a counter to determine when the total volume of water has been reached, e.g., based on a flow rate measured by the flow meter 130 over a period of time. When the flow meter 130 reaches the count value for the appropriate total water volume corresponding to the selected number of cups, the controller 110 may then deactivate the pump 132 in order to ensure the appropriate total water volume is provided.

During each of the above-described phases, and during each stage of the brewing phase, one or more parameters may be varied in response to one or more inputs received from a user interface of the coffee making appliance 100. The one or more parameters may be varied in that a default value (which may be, for example, preprogrammed into a memory of the controller) for the parameter or each parameter is overwritten or superseded by a value which is received from the user input, such as a directly input value, and/or based on the user input, e.g., derived from a user-selected option such as a desired brewing profile or brew type, etc. For example, such parameters may include, in the start phase, a total time for the start phase, the amount of the initial volume of water, a water temperature provided by the heater 136, and/or a flow rate provided by the pump 132. As additional examples, such parameters may include, in the bloom phase, the bloom time and/or the temperature at which water in the heater 136 is maintained while the pump 132 is paused. As still further examples, such parameters may include, in the brewing phase, a time, such as a total time for the brewing phase or a dwell time after brewing, water temperature, flow rate, and one or more water volume amounts, such as a total amount for the second volume of water, or multiple values for amounts of water to be added in different stages of the brewing phase, where such multiple values may sum to the second volume. In some embodiments, one or more of the brewing phase parameters may be varied from one stage to another, with each parameter of each respective phase being independent of every other phase. Additionally, in various embodiments of the present invention, any one or more, up to and including all, of the brewing parameters described in this paragraph may be customizable, e.g., may be directly input by a user (via the control panel or via the remote user interface device 1000, for example), or may be determined based on or otherwise derived from a user input such as a selected brew profile.

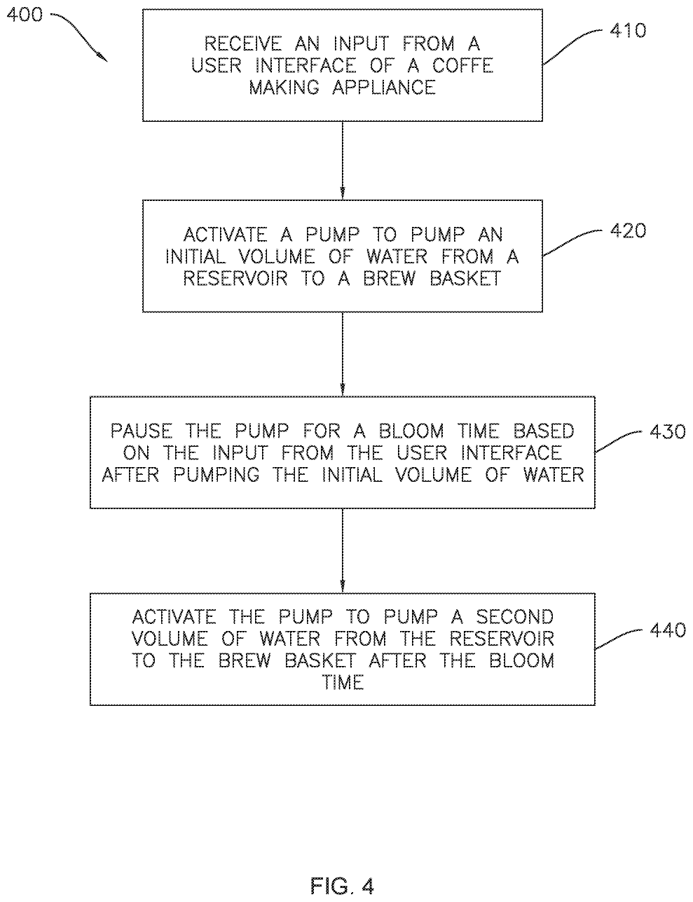

FIG. 4 illustrates an exemplary method 400 for operating a coffee making appliance according to an exemplary embodiment of the present subject matter. Method 400 can be used to operate any suitable coffee making appliance, such as the example coffee making appliance 100 of FIGS. 1 through 3. In particular, controller 110 may be programmed or configured to implement method 400. Utilizing method 400, coffee can be brewed according to specific user preferences. In particular, the bloom time of the brewing operation can be varied in response to a user input, such that each brewing operation may provide a distinct and customized coffee beverage for each user.

As illustrated in FIG. 4, the method 400 may include a step 410 of receiving an input from a user interface of the coffee making appliance. For example, in some embodiments, the user interface may be a local user interface integrated with the coffee making appliance such as the control panel described above, e.g., including the input selectors 106 and/or 108. In additional embodiments, the user interface may also or instead include a remote user interface device 1000, e.g., a smartphone as described above, and the user interface may be provided on the remote user interface device 1000, such as in a smartphone app.

The method 400 may then include a step 420 of activating a pump of the coffee making appliance to pump an initial volume of water from a reservoir of the coffee making appliance to a brew basket of the coffee making appliance. The initial volume of water may be sufficiently large to cover and saturate coffee grounds in the brew basket, while also small enough to avoid or minimize over wetting the coffee grounds. Thus, in some embodiments, the initial volume of water may be a customizable parameter, e.g., may be directly input by a user or may be determined based on a coffee ground quantity entered by the user. For example, the initial volume of water may be provided at a customized flow rate, such as, in some embodiments, a first flow rate which is based on a user input. Further, the initial volume of water may be heated to a first temperature, and such heating may occur prior to and/or concurrently with the step of pumping the initial volume of water.

After pumping the initial volume of water, the method 400 may include a step 430 of pausing the pump for a bloom time. The bloom time may be a custom parameter, e.g., the bloom time may be based on the input from the user interface.

After the bloom time has elapsed, the method 400 may include a step 440 of activating the pump to pump a second volume of water from the reservoir to the brew basket. For example, the step 440 may include a customized temperature and/or flow rate, such as pumping the second volume of water at a second flow rate based on the user input and/or heating (prior to and/or concurrently with pumping) the second volume of water to a second temperature based on the user input. Further, the first and second flow rate may be the same or may differ in various embodiments. Similarly, the first temperature and the second temperature may, in various embodiments, be the same or may differ.

In various embodiments, the input on which the customized bloom time is based may be manually entered, e.g., directly into the local or remote user interface, such that user input consists of a bloom time value. In other embodiments, the bloom time value may be indirectly determined from the input, where the input relates to a source material supplied into the brewing process and/or a desired outcome of the brewing process, and the bloom time value is determined based on the source material or outcome.

For instance, possible desired outcomes may include one or more predefined brewing profiles, which include predetermined values for multiple brewing parameters, such as time, temperature, and flow rate, as described above, in addition to a predetermined bloom time value associated with the or each brewing profile. In such embodiments, the input may include a brew profile, and the brew profile may include a predetermined bloom time value, such that the bloom time of step 430 in such embodiments will be the predetermined bloom time value of the selected or input brewing profile. The brewing profiles may relate to predefined standards, such as specialty coffee association (SCA) standards, and/or desired strength levels of the resultant coffee. For example, the one or more brewing profiles may include a standard profile, e.g., a brewing profile where all parameter values are based on standards such as SCA standards, a light profile for relatively mild coffee, a bold profile for relatively strong coffee, and/or a medium profile for intermediate strength coffee.

In various embodiments, the coffee making appliance and/or the method of operating the coffee making appliance may include a scan-to-brew feature or function.

The scan-to-brew may include scanning, e.g., with image analysis software on the remote user interface device 1000, the coffee beans or grounds (such as packaging thereof) to determine information about the source coffee beans or grounds, and automatically selecting or determining a bloom time value based on the determined information. For example, the image analysis software may capture a photograph of the packaging and derive information, such as a brand of coffee from the photograph, e.g., by recognizing a brand name or logo from the photograph image. As another example, scanning may include scanning a bar code, such as a linear one-dimensional bar code, or a two-dimensional bar code (sometimes also referred to as a QR code), on the packaging to determine the information about the source coffee. In additional embodiments, various coffee bean types or other information about the source coffee may be selectable from a pull-down menu on the user interface. Thus, in various embodiments, the input received from the user interface may be an image or scan of the source coffee, or may be a selection of a source coffee characteristic from a menu such as a pull-down menu on the user interface.

The information about the source coffee may include one or more of a coffee bean type, e.g., regular or espresso, a brand of coffee, a coffee bean roast level, e.g., light roast, medium roast, or dark roast, a coffee bean place of origin, such as country of origin, e.g., Colombia, Ecuador, Jamaica, Ethiopia, etc. The bloom time may then be determined based on the information about the source coffee. For example, such determination may include looking up the information about the source coffee in a lookup table and selecting from the lookup table a bloom time value associated with the information about the source coffee in the lookup table. In some embodiments, the lookup table may be stored in a remote data server and may be accessed by the coffee making appliance via the cloud using the wireless communication module of the coffee making appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a coffee making appliance, the coffee making appliance comprising a reservoir, a pump, and a brew basket, the method comprising:
receiving an input from a user interface of the coffee making appliance;
activating the pump to pump an initial volume of water from the reservoir to the brew basket at a first flow rate based on the input received from the user interface;
heating the initial volume of water to a first temperature based on the input received from the user interface;
pausing the pump for a bloom time after pumping the initial volume of water, wherein the bloom time is based on the input received from the user interface;
activating the pump to pump a second volume of water from the reservoir to the brew basket after the bloom time at a second flow rate based on the input received from the user interface; and
heating the second volume of water to a second temperature based on the input received from the user interface.

2. The method of claim 1, wherein the input consists of a bloom time value.

3. The method of claim 1, wherein the input comprises a brew profile including a bloom time value.

4. The method of claim 1, wherein the input comprises a coffee bean type, further comprising looking up a bloom time value associated with the coffee bean type in a lookup table.

5. The method of claim 1, wherein the input comprises a brand of coffee, further comprising looking up a bloom time value associated with the brand of coffee in a lookup table.

6. The method of claim 1, wherein the input comprises a coffee bean roast level, further comprising looking up a bloom time value associated with the coffee bean roast level in a lookup table.

7. The method of claim 1, wherein the input comprises a coffee bean place of origin, further comprising looking up a bloom time value associated with the coffee bean place of origin in a lookup table.

8. The method of claim 1, wherein the user interface is provided on a remote user interface device.

9. The method of claim 1, wherein the user interface comprises a local user interface integrated with the coffee making appliance.

10. A coffee making appliance, comprising:
a reservoir;
a pump;
a brew basket; and
a controller, the controller configured for:
receiving an input from a user interface of the coffee making appliance;
activating the pump to pump an initial volume of water from the reservoir to the brew basket;
setting a water temperature for the initial volume of water;
setting a first flow rate of the pump for the initial volume of water to a desired level based on the received input from the user interface to achieve precise wetting of the coffee;
pausing the pump for a bloom time after pumping the initial volume of water, wherein the bloom time is based on the input from the user interface;
setting a second water temperature for a second volume of water;
activating the pump to pump the second volume of water from the reservoir to the brew basket after the bloom time; and
setting a second flow rate of the pump for the second volume of water to a desired level based on the received input from the user interface to achieve precise extraction of the coffee during the step of activating the pump to pump the second volume of water.

11. The coffee making appliance of claim 10, wherein the input consists of a bloom time value.

12. The coffee making appliance of claim 10, wherein the input comprises a brew profile including a bloom time value.

13. The coffee making appliance of claim 10, wherein the input comprises a coffee bean type, further comprising looking up a bloom time value associated with the coffee bean type in a lookup table.

14. The coffee making appliance of claim 10, wherein the input comprises a brand of coffee, further comprising looking up a bloom time value associated with the brand of coffee in a lookup table.

15. The coffee making appliance of claim 10, wherein the input comprises a coffee bean roast level, further comprising looking up a bloom time value associated with the coffee bean roast level in a lookup table.

16. The coffee making appliance of claim 10, wherein the input comprises a coffee bean place of origin, further comprising looking up a bloom time value associated with the coffee bean place of origin in a lookup table.

17. The coffee making appliance of claim 10, wherein the user interface is provided on a remote user interface device.

18. The coffee making appliance of claim 10, wherein the user interface comprises a local user interface integrated with the coffee making appliance.
